(19) United States
(12) Patent Application Publication
(10) Pub. No.: US 2024/0324637 A1
(43) Pub. Date: Oct. 3, 2024

(54) PROCESS FOR THE PREPARTION OF A FRYABLE AND BLOCKABLE LIVER SUBSTITUTE

(71) Applicant: ETHICLINE GMBH, Braunschweig (DE)

(72) Inventor: Tobias SUDHOFF, Greven (DE)

(73) Assignee: ETHICLINE GMBH, Braunschweig (DE)

(21) Appl. No.: 18/621,646

(22) Filed: Mar. 29, 2024

(30) Foreign Application Priority Data
Mar. 31, 2023 (EP) 23 165 966.5

(51) Int. Cl. A23L 13/50; A23L 13/40

(52) U.S. Cl. CPC A23L 13/52; A23L 13/428; A23L 13/43; A23L 13/48

(57) ABSTRACT

It is provided a process for producing a foie gras-free product suitable for roasting as a foie gras bloc or foie gras. The present process comprises at least four tempering phases: Tempering phase A as the first heating phase; tempering phase B as the first cooling phase, tempering phase C as the second heating phase or pasteurization phase; and tempering phase D as the second cooling phase of the pasteurized product. The specific temperature control takes into account the specific properties of the protein-fat matrix of the liver tissue and the added fat components, whereby the creamy and compact structure of the product is achieved.

### CROSS-REFERENCE TO A RELATED APPLICATION

The present application claims priority to European Patent Application No. 23165966.5 filed on Mar. 31, 2023. The entire contents of the above-listed application are hereby incorporated by reference for all purposes.

### BACKGROUND

The proposed solution relates to a process for producing a fryable and blockable liver substitute, in particular a foie gras substitute or duck foie gras substitute.

Aquatic poultry can store the energy they need for the long winter flight south in the form of fat in the liver. The liver can store a particularly large amount of fat in the form of triglycerides. The gavage or forced fattening of geese or ducks exploits this ability of the animals and adds so much fat to the simple liver (approx. 100-150 g) that a metabolically pathologically enlarged liver of up to 1.5 kg is created.

The foie gras obtained in this way is a culinary specialty in the high-price segment that is particularly popular in France, but also in many other countries around the world, due to its sensory properties as well as its pairing possibilities and combinability.

However, the production of this specialty is associated with ethically highly critical forced fattening and is therefore heavily criticized worldwide. Many countries have now banned the production and, in some cases, the sale of foie gras in any form due to these circumstances. It is therefore of great importance for the culinary scene to have a suitable substitute product available.

Processes for the production of foie gras-free liver mousse (CH 690 413 A5) or liver pâté (EP 3 556 224 B1) are known. However, these differ from a bloc foie gras, particularly in terms of consistency and sensory properties or mouthfeel.

In any case, there are very few products on the market that are suitable either as bloc foie gras or as foie gras for roasting. However, a product that meets both requirements does not yet exist on the market.

### SUMMARY

Accordingly, the object underlying the proposed solution was to provide a process for producing a substitute product for a bloc foie gras, whereby the use of foie gras can be dispensed with and at the same time has the sensory properties of a bloc foie gras.

Furthermore, only additives permitted in organic farming should be used to enable the product to be certified organic. In particular, this made it necessary to enable the rheological properties of the matrix through natural ingredients and temperature control throughout the process.

This problem is solved by a process with the features as described herein.

Accordingly, a process for producing a fryable and blockable liver substitute is provided, which comprises the following steps:
Providing at least part of an animal liver and removing the connective tissue from the animal liver,
Mixing the liver mass free of connective tissue with additives for sensory and taste adjustment,
mechanical processing of the liver mass into an emulsion,
Providing at least one liquefied food fat and at least one alcoholic beverage liquid,
Mixing the liver emulsion with the liquid food fat and the alcoholic beverage liquid, and heating the liver mixture in a first tempering phase A to a temperature between 55-64° C., preferably 57-60° C., particularly preferably 58° C. with a temperature gradient of 1-5° C./1-5 minutes, preferably 1-1.5° C./3 minutes, during the first tempering phase A at a temperature of 42-50° C., preferably 45-49° C., particularly preferably at 46-48° C., addition of an emulsifier mixture of egg yolk and at least one phospholipase to the liver mixture,
after reaching a core temperature of the liver emulsion of 55-64° C., preferably 57-60° C., particularly preferably 58° C., cooling the mixture of liver, emulsifier, food fat, alcoholic beverage liquid and optional additives in a second tempering phase B to a temperature of 28-35° C., preferably 30-33° C., particularly preferably 32° C. with a temperature gradient of 1-2° C./minute, preferably 1.5° C./minute with simultaneous stirring of the mass with a mixing device to form a homogeneous cream,
during the second tempering phase B at a temperature of 45-53° C., preferably 47-50° C., particularly preferably 48-49° C., adding further emulsifier mixture of egg yolk and at least one phospholipase to the liver cream,
when the liver cream reaches a final temperature of 30-35° C., preferably 32-33° C., the liver cream is filled under pressure into suitable packaging,
Heating the packages filled with the liver cream in a third tempering phase C to a temperature of 63-75° C., preferably 65-75° C., particularly preferably 68-72° C. in a steam atmosphere and, after reaching the temperature, pasteurizing the packages filled with the liver cream for a period of 30-90 minutes, preferably 35-70 minutes, particularly preferably 40-50 minutes,
after completion of the pasteurization process, cooling of the pasteurized liver cream in a fourth tempering phase D to a final temperature of the liver cream of 2-4° C.

The present process makes it possible to provide a product that is suitable for roasting as bloc foie gras or foie gras.

The present process comprises at least four tempering phases: Tempering phase A as the first heating phase; tempering phase B as the first cooling phase, tempering phase C as the second heating phase or pasteurization phase; and tempering phase D as the second cooling phase of the pasteurized product. The specific temperature control takes into account the specific properties of the protein-fat matrix of the liver tissue and the added fat components, whereby the creamy and compact structure of the product is achieved.

The process forms a protein-fat-water matrix in the liver tissue used, which essentially enables a stable structure after heating by denaturing the proteins due to the arrangement of the fat vacuoles. For bloc foie gras, the structure is achieved by slow cooking at low temperatures at best, which may be made more uniform by homogenization processes. The result is a spreadable mass. With raw foie gras, this is achieved through the roasting process.

Both are characterized by a particularly fine, creamy and yet compact structure; i.e. a low viscosity without gel-like structures with higher shear forces that enable the compactness. In fried foie gras, the melted fat components are trapped in the protein matrix and are released in mechanical processes in the mouth. The characteristics of Bloc Foie Gras are essentially determined by the melt.

In bloc foie gras, the fats are present as long-chain triglycerides (in contrast to poultry flom fat, liver fat contains fewer short chains and fewer unsaturated fatty acids), which are present in the usual chair conformation within the vacuoles and free mycelia of lipoproteins. During homogenization and also through the heating process, the vacuoles are broken up and further triglycerides enter the matrix and are partly stored in mycelia. During the solidification process, the high fat content (up to 95%) results in rheological properties that are determined by shear forces and viscosity. In addition, some of the triglycerides melt conspicuously endothermically, which means that the Bloc Foie Gras melts cooling in the mouth, which is generally perceived as very pleasant.

Furthermore, the ratio of saturated to unsaturated fatty acids in the triglycerides is important for the melting behavior. The ratio of S (saturated) to U (unsaturated) shifts towards S for most fats in the Bloc Foie Gras and therefore plays less of a role in the process.

The gustatory and olfactory sensory properties of foie gras essentially result from the proteins in the liver tissue and require that these molecules are also available in an imitation. This is achieved by adding fat. For this purpose, three properties are essentially copied rheologically by structuring the matrix accordingly and, in particular, the properties of temperature control and protein properties are used as emulsifiers in the matrix. The egg yolk mixture used as an emulsifier plays a special role here, as does the folding behavior of the proteins under the influence of temperature and time.

In the present process, poultry liver, in particular goose liver or duck liver, pork liver, beef liver, rabbit or hare liver or deer liver will be used as animal liver. The use of poultry foie gras is explicitly excluded for ethical reasons. Rather, the present process enables the production of a poultry foie gras substitute, in particular a goose foie gras substitute or duck foie gras substitute.

In one embodiment of the present process, additives are added to the liver mass for sensory and flavor adjustment, wherein the additives may be spices such as thyme, rosemary, sage, onion, celery, leek, salt, sugar, bouillon, chicken stock, preferably dried chicken stock, antioxidants, in particular ascorbic acid. Preferred additives are thyme, salt, sugar, bouillon, dried chicken stock, ascorbic acid.

Truffles, chocolate, curry, chilli, fruit sauces, fruit jams, dried fruit, nuts and the like can be added to create a variety of flavors.

Furthermore, a nitrite salt, for example and in particular sodium and/or potassium nitrite salt, is added for preservation.

The liver mass mixed with the additives is mechanically processed into an emulsion. This processing can take place in a conventional butcher's cutter, for example. Cutting is preferably carried out in such a way that the liver tissue is conditioned to a creamy consistency and/or the liver tissue remains free of foci.

In one embodiment of the present process, butter, nut butter, coconut fat and/or phlom fat are used as food fats. Nut butter, coconut fat and phlom fat are particularly preferred.

The term “butter” refers to a product that is usually made from cow's milk, but is also available in a plant-based version. The term “nut butter” refers to a lightly browned liquid butter that has been strained through a cloth and gets its name-giving nutty taste from caramelized lactose.

The term “coconut fat” (also known as coconut oil) refers to a white to yellowish-white vegetable fat that is obtained from the coconut, the fruit of the coconut palm. Preferably, deodorized coconut oil is used to avoid irritating sensory effects. The particular advantage of coconut fat is that it melts endothermically as a fat rich in lauric acid.

According to the solution, the term “phlom” is understood to mean the fat of the peritoneum and/or the kidneys of animals. Particularly preferably, the phlom fat used originates from a poultry species, in particular from goose or duck. Preferably, the phlom comes from the poultry species that supplies the liver tissue.

The at least one food fat is provided at a temperature between 40 and 45° C., preferably 43-44° C., i.e. in liquid form, which facilitates addition and mixing with the liver mass.

In one embodiment, nut butter, phlom and coconut fat are mixed at a temperature of about +120 degrees Celsius for about 15 minutes with gentle stirring, after which this fat mixture is allowed to cool to about +60 degrees Celsius. In this context, in order to increase the sensory qualities, it is advantageous for the heated mass of nut butter, phlom and coconut oil to be sieved through a sieve with a maximum mesh size of approx. 0.5 mm at a temperature of approx. +50 degrees Celsius in order to increase the homogeneity.

The fat content of the liver tissue used is determined in advance histologically and by evaporation in order to draw conclusions about the fat content required for the desired product in conjunction with the weight. If the fat content of the liver tissue used is too low, the determined lack of fat is compensated for by adding nut butter. This applies in particular if the livers are not so-called autumn livers or even completely different livers that can be processed in the same way as deer liver.

At least one brandy, in particular gognac or Armagnac, wine, in particular white port or Madeira, can be used as the alcoholic beverage liquid added to the liver mass.

As mentioned, the liver mixture of liquid nut butter, coconut fat and brandy, in particular cognac, is heated in a first tempering phase A. In one embodiment of the present process, in the first tempering phase A, the liver mixture of liquid nut butter, coconut fat and brandy, in particular cognac, is heated for example from 35° C. to 58° C. with a temperature gradient of 1-1.5° C./3 minutes.

As also mentioned above, in the first tempering phase A, an emulsifier mixture of egg yolk and at least one phospholipase is added to the liver mixture at a temperature of 42-50° C., preferably 45-49° C., particularly preferably at 46-48° C.

In one variant, the egg yolk phospholipase emulsifier mixture used comprises between 1-2 g, preferably 1.5 g of at least one phospholipase per kg of egg yolk.

The use of phospholipase causes a reduction in the size of the fat mycelia present in the liver mixture. It has been shown that the size of the fat mycelia has an influence on the creaminess of the product. In addition to the long chains of triglycerides, the surface-active phopholipids present in the fat mycelia play an important role. These have a significant influence on the size of the phospholipid mycelia. By using phospholipase, mycelia can be reduced to a maximum size.

Phospholipases are enzymes that are usually found in the pancreatic secretion in the body, where they take on the task of breaking down phopholipids. This group of enzymes is categorized into phospholipases A, B, C and D depending on where they perform the cleavage in the molecule: Phospholipase A 1cleaves an unsaturated fatty acid at its ester bond at the C1 atom; Phospholipase A: cleaves 2an unsaturated fatty acid at its ester bond at the C2 atom; Phospholipase B can cleave the fatty acid ester bond at Sn-1 and Sn-2 position, Phospholipase C cleaves before phosphorus atom of the phosphate group, Phospholipase D cleaves after phosphorus atom

Chimeric phospholipases are also known, in which genes of lipases from different organisms have been combined. A well-known chimeric phospholipase is lecitase, which is produced by the fusion of the genes of the lipase from Thermomyces lanuginosus and the phospholipase A1 from Fusarium oxysporum

A phospholipase A2 is preferably used in the present process.

In addition to the effect of phospholipase, the interfacial activity of the egg yolk proteins plays a role in emulsion formation. The salt contained in the liver mixture also has a strong influence on colloid formation in the temperature control process.

The emulsifier mixture of egg yolk and at least one phospholipase is prepared in a process comprising the following steps:
a) Preparation of egg yolk and addition of at least one phospholipase to the egg yolk;
b) Activating the at least one phospholipase by heating the mixture of egg yolk and phospholipase to a temperature between 45 and 65° C., preferably between 50 and 60° C., in particular preferably between 54 and 60° C. depending on the activation temperature of the phospholipase. This can be done, for example, in a convection oven at a humidity of 80-95%.
c) maintaining the mixture of egg yolk and phospholipase at a temperature of between 50 and 60° C., preferably between 54 and 60° C., for a period of 2 to 4 hours, and
d) subsequent deactivation of the phospholipase by heating the mixture of egg yolk and phospholipase to a temperature of between 60 and 90° C., preferably between 65 and 85° C., more preferably between 68 and 80° C., particularly preferably between 74 and 78° C. for a period of 5 to 15 minutes, preferably 6 to 12 minutes, and obtaining the ready-to-use emulsifier mixture.

As mentioned, the egg yolk-phospholipase emulsifier mixture is added to the liver mixture in the first tempering phase A, which corresponds to a first heating phase, and mixed, whereby the liver mixture is emulsified.

After reaching a core temperature of the liver emulsion of 57-60° C., particularly preferably 58° C., the liver emulsion is cooled in a second tempering phase B (first cooling phase) to a temperature of 30-33° C., particularly preferably 32° C. with a temperature gradient of 1.5° C./minute with simultaneous stirring of the mass with a mixing device, particularly with an emulsification mixer (such as a hand blender) at at least 8000 rpm, to form a homogeneous cream.

In one embodiment, further alcohol, in particular brandy, can be added to the liver emulsion during cooling and stirring in this cooling phase.

As mentioned above, further egg yolk-phospholipase emulsifier mixture B is also added in this tempering phase, in particular at a temperature of 48° C. +-0.5° C.

In the subsequent filling step, the liver cream is filled into jars or sausage casings once it has reached a final temperature of 30-35° C., preferably 32-33° C.

The packages filled with the liver cream are heated in a third tempering phase C (a second heating phase) to a temperature of 63-75° C., preferably 65-75° C., particularly preferably 68-72° C., preferably with 100% steam. After reaching the (core) temperature, the packages filled with the liver cream are pasteurized for a period of 30-90 minutes, preferably 35-70 minutes, particularly preferably 40-50 minutes. It should be noted that temperature and time are interdependent during the pasteurization process, i.e. the lower the temperature, the longer the pasteurization time and vice versa. In a particularly preferred embodiment, the pasteurization temperature is between 68 and 72° C. and the pasteurization time is between 45 and 60 minutes.

In the fourth tempering phase D (second cooling phase) following the pasteurization process, the pasteurized liver cream is initially cooled in a first step at a temperature of between −18° C. and −22° C., preferably −20° C., to a core temperature of 16 to 24° C., preferably 18 to 22° C., particularly preferably 20° C. Cooling in this step therefore takes place with a steep temperature gradient. The rapid cooling serves to fix the matrix, as otherwise hydrogen bonds and disulphide bridges would form between fatty acids, resulting in a crystalline structure.

After reaching the core temperature of 16 to 24° C., preferably 18 to 22° C., particularly preferably 20° C., the cooling process is slowed down and the liver cream in the packaging is cooled in a second step at a temperature of −4° C. to 0° C., preferably −3° C. to −1° C., particularly preferably −2° C. to a temperature of 2 to 4° C.

The product produced with the present process at exactly this temperature curve has all the properties of a Bloc Foie Gras: the melt corresponds to that of a conventional Bloc Foie Gras in terms of viscosity, shear forces and mouthfeel due to the conformation, the shortened phopholipids, the size of the mycelia, the unfolding and only partial denaturation of the proteins and the endothermic melting of the coconut fats—as could be demonstrated in a texture measuring device. It therefore also differs fundamentally from a Pathé, in which the proteins cannot perform this type of interfacial activity in a controlled manner due to the lack of temperature control and cannot achieve this type of compactness in the mass, nor are the mycelia so small due to the lack of enzymes, nor does the Pathé achieve this creaminess due to the lower fat content.

There are also sufficient fats and the typical liver flavors to correspond to foie gras, as proven by a double blind test conducted by the Münster University of Applied Sciences (Prof. Thorsten Sander) with experienced foie gras consumers.

The resulting mass also makes it possible to fry this bloc foie gras: There are enough non-denatured proteins present to form a firm coating of denatured proteins and an inner, protein-stabilized structure at very high temperatures in the pan. At temperatures of around 40° C., the core of the mass retains its creamy structure without falling apart, but then has the typical browning reactions (Maillard) on the surface that are desired in fried foie gras.

The special tempering process in combination with the recipe thus enables a new type of product-bloc foie gras and fryable foie gras at the same time, in handy packaging and without the ethically extremely questionable collateral effects of forced stuffing or force-feeding.

The solution is discussed in detail below with reference to several embodiments.

### Example 1: A First Embodiment of the Process According to the Solution

The connective tissue is removed from the liver using a centrifugal press. The mass is seasoned with salt, sugar, seasonings, dried chicken stock, ascorbic acid as an antioxidant and then mechanically processed in a cutter to form a very fine cream/emulsion. This ionizes the sodium chloride and makes it available as ions in the process.

The butter is processed into nut butter and kept warm (approx. 44° C.). The coconut fat is also dissolved in the nut butter. Nut butter, coconut fat and the liver mass are now whipped in a kettle together with cognac using a high-speed hand blender to form a homogeneous mass and heated slowly. In test series, a temperature control between 35° C. and approx. 55° C. at a speed of approx. 1° C./3 minutes was found to be optimal. Slower temperatures give the proteins too much time to denature during unfolding, faster temperatures partially denature the proteins in the higher temperature range due to a higher delta T in the mass and result in an imbalance of unfolding and irreversibly damaged proteins.

At 48° C., the egg yolk-phospholipase mixture is introduced into the process and the liver mixture is emulsified up to 52° C. using the hand blender. In this temperature range, the first proteins (initially alpha-livetin, then conalbumin and further proteins due to enthalpy) unfold along the oil/water interface according to steric conditions. This process takes place from 52° C. with stirring by an agitator without further mechanical emulsifying influence in the heating phase (tempering phase A). Colloids are formed, which are sometimes only carefully dissolved with the agitator. These clusters are not mycelium formations, but rather the careful unfolding of the egg yolk proteins and the opening of the hydrophobic heart of the proteins to the fat-existing mycelium remains stable in the environment, but no more is formed, fat is released in the environment of the colloids. This process is intentional. The protein packs swell to a size of up to 1.5 cm—this appears to be optimal.

When a core temperature of 58° C. is reached, maximum protein clusters form in a loose arrangement; higher temperatures cause irreversible denaturation of the egg yolk proteins and also destabilize the lipoproteins in the phase. Intensive monitoring of the temperature in the boiler is now necessary; nowhere should a delta T greater than 3° C. occur-this is ensured by the agitator and the clean temperature control of the boiler.

When the core temperature of the liver mass reaches 58° C., the cooling is suddenly switched on (tempering phase B), the mass is now cooled at approx. 1.5° C. per minute, further cognac is added and the mass is emulsified with the high-performance mixer. This not only ensures maximum homogeneous temperature distribution but also particularly intensive emulsification: the unfolded proteins can now align themselves along the aqueous phase, especially with the alpha-helical parts, and the lipids in the lipophilic fraction can now arrange themselves. The mechanical movement results in a high degree of amorphous solidification pattern of the fats, any mycelia that have joined together are broken down again into smaller units and the first long-chain fatty acid residues arrange themselves. At 48° C., egg yolk is added to the process (which is subject to denaturation and unfolding processes, especially later in the pasteurization process) and allow the temperature to drop as emulsification continues.

In this way, a homogeneous cream is obtained, which is filled under pressure (filling machine) when a core temperature of 32° C. is reached. The filled mass does not fall below a temperature of 25° C., so that the fatty acids are still present in a fairly fluid, non-solidified form. The chains in the mycelia that have been shortened by the enzyme and the protein structure in the matrix, which does not yet stabilize the fatty acids further due to the second addition of emulsifying egg yolk, are used for this purpose. In this way, the matrix contains an extremely unstable mixture of different fatty acid conformations (alpha, beta and beta conformation) and numerous interfacial activities and, in particular, very small and protein-stabilized mycelia (enzyme) within this matrix, which is structurally stabilized by the subsequent pasteurization in a third step (tempering phase C).

The filled mass, which will remain in the packaging form (jars, sausage casings, etc.), must not be shaken much at this stage (to prevent mycelium agglomeration) and is now pasteurized in a combi-steamer at a temperature of 72° C. and 100% steam. As soon as the core temperature of 69° C. is reached, it is set in the combi-steamer and pasteurized for 45 minutes (this is sufficient for a shelf life of 9 months). In addition, the proteins from the egg yolk from the second phase unfold, rearrange themselves in a surface-active manner and finally stabilize the matrix.

After 45 minutes, the heated jars are again placed directly in a freezer (chassis) with as little vibration as possible and subjected to an extreme drop in temperature (tempering phase D): At approx. −20° C., the temperature plummets to below the solidification temperature of the fats in the matrix (at approx. 18° C., all the fats contained are conformed) but without falling below the freezing point. At 18° C., the temperature curve is less steep and goes up to 2° C.

The resulting mass at exactly this temperature process gives all the characteristics of a Bloc Foie Gras. The resulting mass also makes it possible to roast this bloc foie gras.

### Example 2: General Recipe

Recipe

| | |
|---|---|
| Ground sausage meat | Spices |

| | | | | | |
|---|---|---|---|---|---|
| Liver | 50 | kg | Butter | 37.33 | kg |
| Flomen | 0.833 | kg | Coconut oil | 5.833 | kg |

| | | |
|---|---|---|
| Truffle butter | | |
| Cognac expensive | 1000 | ml |
| Cognac | 1500 | ml |
| Egg yolk | 7.300 | kg |
| Whole egg | 1.900 | kg |
| Salt | 1.116 | kg |
| Truffle salt | | |
| Sugar | 1.300 | kg |
| Bouillon | 0.266 | kg |
| Thyme | 0.033 | kg |
| Agar agar | 0.120 | kg |
| Nitrite | 0.007 | kg |
| Vitamin C | 0.044 | kg |
| Lipomod | 8.0 | ml |

### Example 3: Duck Liver

Contents calculated on 10 k g duck liver tissue:
Butter: 7,65 kg
Coconut: 1,17 kg
Phlom: 0,17 kg
Cognac cheap: 0.3 L
Salt: 223 g
Sugar: 184 g
Bouillon: 54 g
Thyme: 7 g
Nitrite: 1.4 g
Vit C: 7.8 g
Lecitase Ultra: 3.2 g
Egg yolk: 1.46 kg phospholipase A2 enzyme activated (=2.1 kg total egg yolk in the calculation)
Whole egg: 0.366 kg
Agar 30 g to 0.4 liters of water
Fine cognac: approx. 300 ml

### Example 4: Goose Liver

Contents calculated on 10 kg goose liver tissue:
Butter: 7.666 kg
Coconut: 1.166 kg
Phlom: 0.333 kg
Cognac cheap: 0.3 L
Salt: 216 g
Sugar: 183 g
Bouillon: 53 g
Thyme: 6 g
Nitrite: 1.4 g
Vit C: 8.5 g
Lecitase Ultra 3.2 g
Egg yolk: 1.46 kg enzyme-activated (=2.1 kg total egg yolk in the calculation)
Whole egg: 1.3 kg
Agar 26 g to 0.38 liters of water
Min approx. 900-1100 ml cognac:

1. A process for the production of a fryable and blockable liver substitute, comprising the following steps
Providing at least part of an animal liver and removing the connective tissue from the animal liver,
Mixing the liver mass free of connective tissue with additives for sensory and taste adjustment,
mechanical processing of the liver mass into an emulsion,
Providing at least one liquefied food fat and at least one alcoholic beverage liquid,
Mixing the liver emulsion with the liquid food fat and the alcoholic beverage liquid, and heating the liver mixture in a first tempering phase A to a temperature between 55-64° C., preferably 57-60° C., particularly preferably 58° C. with a temperature gradient of 1-5° C./1-5 minutes, preferably 1-1.5° C./3 minutes,
during the first tempering phase A at a temperature of 42-50° C., preferably 45-49° C., particularly preferably at 46-48° C. addition of an emulsifier mixture of egg yolk and at least one phospholipase to the liver mixture,
after reaching a core temperature of the liver emulsion of 55-64° C., preferably 57-60° C., particularly preferably 58° C., cooling the mixture of liver, emulsifier, food fat, alcoholic beverage liquid and optional additives in a second tempering phase B to a temperature of 28-35°° C., preferably 30-33° C., particularly preferably 32° C. with a temperature gradient of 1-2° C./minute, preferably 1.5° C./minute with simultaneous stirring of the mass with a mixing device to form a homogeneous cream,
during the second tempering phase B at a temperature of 45-53° C., preferably 47-50° C., particularly preferably 48-49° C., adding further emulsifier mixture of egg yolk and at least one phospholipase to the liver cream,
When the liver cream reaches a final temperature of 30-35° C., preferably 32-33° C., the liver cream is filled under pressure into suitable packaging,
Heating the packages filled with the liver cream in a third tempering phase C to a temperature of 63-75° C., preferably 65-75° C., particularly preferably 68-72° C. in a steam atmosphere and, after reaching the temperature, pasteurizing the packages filled with the liver cream for a period of 30-90 minutes, preferably 35-70 minutes, particularly preferably 40-50 minutes,
after completion of the pasteurization process, cooling of the pasteurized liver cream in a fourth tempering phase D to a final temperature of the liver cream of 2-4° C.

2. The process according to claim 1, wherein a poultry liver, in particular goose liver or duck liver, pork liver or beef liver is used as the animal liver.

3. The process according to claim 1, wherein spices, such as thyme, salt, sugar, bouillon, chicken stock, preferably dried chicken stock, antioxidants, in particular ascorbic acid, are used as additives for sensory and taste adjustment.

4. The process according to claim 1, wherein nut butter, coconut fat and/or phlom fat are used as food fats.

5. The process according to claim 4, wherein the at least one food fat is provided at a temperature of between 40 and 45° C., preferably 43-44° C.

6. The process according to claim 1, wherein at least one brandy, in particular Gognac or Armagnac, wine, in particular white port or Madeira, is used as the alcoholic beverage liquid.

7. The process according to claim 1, wherein in the first tempering phase A, a liver mixture of liquid nut butter, coconut fat and brandy, in particular cognac, is heated to 58° C. with a temperature gradient of 1-1.5° C./3 minutes.

8. The process according to claim 1, wherein the egg yolk phospholipase emulsifier mixture comprises between 1-2 g, preferably 1.5 g of at least one phospholipase per kg of egg yolk.

9. The process according to claim 1, wherein after reaching a core temperature of the liver emulsion of 57-60° C., in particular preferably 58° C., the liver emulsion is cooled in a second tempering phase B to a temperature of 30-33° C., particularly preferably 32° C. with a temperature gradient of 1.5° C./minute with simultaneous stirring of the mass with a mixing device, in particular with an emulsifying rod mixer at at least 8000 rpm, to form a homogeneous cream.

10. The process according to claim 1, wherein further emulsifier mixture of egg yolk and at least one phospholipase is added during the second tempering phase B at a temperature of 48° C. +−0.5° C.

11. The process according to claim 1, wherein the liver cream is filled into jars or sausage casings when the liver cream reaches a final temperature of 30-35° C., preferably 32-33° C.

12. The process according to claim 1, wherein the packages filled with the liver cream are heated with 100% steam in a third tempering phase C and pasteurized for 40-50 minutes, preferably 45 minutes, after reaching the core temperature of 68-72° C.

13. The process according to claim 1, wherein, after the pasteurization process, the pasteurized liver cream is cooled in the fourth tempering phase in a first step initially at a temperature of between −18° C. and −22° C., preferably −20° C., to a core temperature of 16 to 24° C., preferably 18 to 22° C., in particular preferably 20° C., and is cooled in a second step at a temperature of −4° C. to 0° C., preferably −3° C. to −1° C., in particular preferably −2° C., to a temperature of 2 to 4° C.
